(19) United States
(12) Patent Application Publication
(10) Pub. No.: US 2026/0289650 A1
(43) Pub. Date: Sep. 24, 2026

(54) Interactive Gift Shopping and Management System

(71) Applicant: Helen Cascaddan, Sacramento, CA (US)

(72) Inventor: Helen Cascaddan, Sacramento, CA (US)

(21) Appl. No.: 19/365,391

(22) Filed: Oct. 22, 2025

Related U.S. Application Data
(60) Provisional application No. 63/775,356, filed on Mar. 21, 2025.

(51) Int. Cl. G06Q 30/0601; G06Q 20/20

(52) U.S. Cl. CPC G06Q 30/06331; G06Q 20/208; G06Q 30/0641

(57) ABSTRACT

An interactive gift shopping and management system configured to simplify the creation, sharing, and tracking of digital wish lists. The system includes recipient and purchaser devices executing a mobile or software application that communicates with a centralized server through a network. The server incorporates modules for user profile management, wish list synchronization, product identification, purchase tracking, and messaging. The system enables users to add products by scanning images or barcodes, share wish lists through secure invitations, and coordinate purchases among multiple participants. Role-based filtering enables purchasers to view complete wish-list details, comprising purchased or reserved items, and recipients view only unpurchased items, preserving the surprise of gift giving.

### CROSS-REFERENCE TO RELATED APPLICATION

The present application claims priority to, and the benefit of, U.S. Provisional Application No. 63/775,356 which was filed on Mar. 21, 2025 and is incorporated herein by reference in its entirety.

### FIELD OF THE INVENTION

The present invention generally relates to digital shopping and gift coordination systems. More specifically, the present invention relates to an interactive gift shopping and wish-list management system configured to enable users to create, share, and track digital gift lists while maintaining privacy and preserving the surprise of gift giving. The invention comprises a multi-component architecture including a software application executable on recipient and purchaser devices and a server system hosting interconnected modules for user profile management, wish-list synchronization, product discovery, purchase tracking, and messaging. The software application provides a plurality of user interfaces enabling recipients to build and share wish lists, purchasers to coordinate and track purchases, and all participants to communicate within a unified platform. The server implements role-based visibility controls ensuring that purchasers can view purchased items and reserved items while recipients are shown only unpurchased items, thereby preventing premature disclosure of gifts and enhancing the gift-giving experience. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals frequently utilize online platforms or mobile applications to create personal wish lists identifying products they desire for special occasions such as birthdays, holidays, or celebrations. The lists are commonly shared with friends and family to simplify the process of gift selection and to reduce the likelihood of receiving unwanted or duplicate items.

However, existing wish-list systems and applications display real-time purchase updates directly to the recipient, enabling them to see when an item has been bought or reserved. As a result, recipients may prematurely learn what gifts they will receive, thereby diminishing the excitement and spontaneity traditionally associated with gift-giving occasions. Furthermore, existing systems offer limited collaboration features among multiple purchasers and lack privacy controls that distinguish between recipient and purchaser visibility. Accordingly, individuals desire an improved interactive gift management system that enables recipients to create and share wish lists, enables multiple purchasers to coordinate their buying activities, and conceals purchase information from the recipient to maintain the surprise and enjoyment inherent in gift-giving.

Therefore, there exists a long-felt need in the art for an improved interactive gift management system that overcomes the limitations of conventional wish-list and gift-tracking applications. There is a need for a system that enables recipients to easily create and share personalized wish lists while enabling multiple purchasers to view, coordinate, and track purchases in real time. Furthermore, there is a need for an application that preserves the element of surprise in gift giving by concealing purchase activity and related information from the intended recipient. Additionally, there exists a need for a unified platform that integrates product discovery, list sharing, purchase tracking, and messaging within a single, secure environment. Finally, there is a need for a network-based gifting solution that facilitates group coordination, prevents duplicate purchases, and maintains data synchronization across all connected devices without compromising user privacy.

The subject matter disclosed and claimed herein, in one embodiment, comprises an interactive gift shopping and management system configured to simplify the creation, sharing, and tracking of digital wish lists. The system includes one or more recipient devices and one or more purchaser devices, each executing a mobile application that provides graphical user interfaces for managing wish lists and coordinating group activities. The devices communicate with a centralized server system through a network connection. The server system includes a plurality of software modules such as a user profile database for storing user and group associations, a wish list management module for synchronizing item data, a product finder and catalog module for identifying products through scanning or search queries, a purchase tracking module for updating purchase status in real time, and a messaging module for user collaboration. The system operates under a role-based visibility model wherein purchasers view all items, including purchased items or reserved ones, while recipients view only unpurchased items, thereby preserving gift secrecy.

In this manner, the interactive gift management system of the present invention overcomes the long-standing deficiencies of existing wish-list and gift-tracking technologies by providing a secure, synchronized, and privacy-aware solution for digital gift coordination. The system enables multiple purchasers to collaborate effectively, reduces redundant purchases, and maintains real-time synchronization across user devices. The combination of product discovery, role-based privacy filtering, and in-app messaging ensures an efficient and enjoyable gift-giving process for all participants. The invention preserves the excitement of gift-giving by ensuring that recipients remain unaware of which items have been purchased, while purchasers benefit from improved communication and coordination tools.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an interactive gift shopping and management system designed to enable users to create, share, and track digital wish lists in a coordinated and privacy-preserving manner. The system includes recipient and purchaser devices that each execute a software application configured to present user interfaces for creating, editing, and managing wish lists. A centralized server communicates with these devices over a network and hosts several functional modules, including a user profile database for storing user account data and associations, a wish list management module for synchronizing list content, a product finder and catalog module for retrieving item data from merchant sources, a purchase tracking module for updating and preventing duplicate purchases, and a messaging module for facilitating communication among users. The system applies role-based filtering of list data such that purchasers view all items including purchased items, while recipients only see unpurchased items, thereby maintaining the surprise element of gift giving.

In another embodiment, a computer-implemented method for creating and sharing a digital wish list is described. The method involves receiving a command from a user to create a new wish list that may correspond to a specific event or occasion. The user adds desired products to the list through manual entry, barcode scanning, or keyword search, and the system stores the list data on a remote server. The method further enables the user to share the wish list with one or more authorized purchasers by generating invitations or secure links, enabling others to access and collaborate on the list.

In yet another embodiment, a computer-implemented method for identifying and adding products to a wish list is described. The method begins when a user captures an image or barcode of a product using a device camera or scanning component. The captured data is then analyzed to query one or more product databases or retail APIs to obtain detailed product information such as name, price, and vendor source. Once the product is identified, the system enables the user to add it directly to a personal wish list or to share it with a designated group for collaborative review. The addition is synchronized across all authorized devices in real time through a server.

In still another embodiment, the server system configured to manage digital wish lists while preserving the privacy of recipients. The server includes one or more processors executing instructions to receive list data requests from client devices, determine the requesting user's role as a recipient or purchaser, and apply role-based visibility rules. Purchasers receive the list data showing all purchase and reservation information, while recipients receive filtered lists that exclude any purchased item indicators or purchaser identifiers.

In still another embodiment, the Gift-it (i.e., electronic) application displays a user interface containing multiple item entries associated with gift events and provides navigation elements for shopping, list management, notifications, and search functions. Users can scan products, view and manage wish lists, and communicate with other users through synchronized interactions with the server. The user interface dynamically reflects updates made by authorized purchasers while concealing such purchase information from recipients, thereby supporting collaborative gift planning and maintaining privacy.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram view of system architecture of interactive gift shopping and management system of the present invention in accordance with the disclosed architecture;

FIG. 2 illustrates an exemplary user interface displayed by the Gift-it (i.e., electronic) application, according to one embodiment of the present invention;

FIG. 3 illustrates an exemplary user interface of a recipient device executing the Gift-It mobile application, showing a personal wish list of a recipient according to one embodiment of the present invention;

FIG. 4 illustrates an exemplary embodiment of a product finder interface displayed by the Gift-it (i.e., electronic) application on a recipient device, according to one embodiment of the present invention;

FIG. 5 illustrates an exemplary embodiment of an interactive list interface offered by the Gift-it (i.e., electronic) application, as displayed on a recipient or purchaser device according to one embodiment of the present invention;

FIG. 6 illustrates an exemplary embodiment of a notifications and messaging interface offered by the Gift-it (i.e., electronic) application of the present invention in accordance with one embodiment of the disclosed architecture;

FIG. 7 illustrates an exemplary flow diagram depicting a method for creating and sharing a wish list using the Gift-it (i.e., electronic) application in accordance with the disclosed architecture;

FIG. 8 illustrates an exemplary method for identifying and adding a product to a wish list or shared group using the Gift-it (i.e., electronic) application, according to one embodiment of the present invention; and

FIG. 9 illustrates an exemplary method for tracking purchases and preserving recipient privacy within the Gift-it (i.e., electronic) application in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved interactive gift management system that overcomes the limitations of conventional wish-list and gift-tracking applications. There is a need for a system that enables recipients to easily create and share personalized wish lists while enabling multiple purchasers to view, coordinate, and track purchases in real time. Furthermore, there is a need for an application that preserves the element of surprise in gift giving by concealing purchase activity and related information from the intended recipient. Additionally, there exists a need for a unified platform that integrates product discovery, list sharing, purchase tracking, and messaging within a single, secure environment. Finally, there is a need for a network-based gifting solution that facilitates group coordination, prevents duplicate purchases, and maintains data synchronization across all connected devices without compromising user privacy.

The present invention, in one exemplary embodiment, is a computer-implemented method for identifying and adding products to a wish list. The method begins when a user captures an image or barcode of a product using a device camera or scanning component. The captured data is then analyzed to query one or more product databases or retail APIs to obtain detailed product information such as name, price, and vendor source. Once the product is identified, the system enables the user to add it directly to a personal wish list or to share it with a designated group for collaborative review. The addition is synchronized across all authorized devices in real time through a server.

Reference will now be made in detail to the present preferred embodiments of the invention, examples of which are illustrated in the accompanying drawings. Wherever possible, the same reference numerals are used in the drawings and the description to refer to the same or like parts.

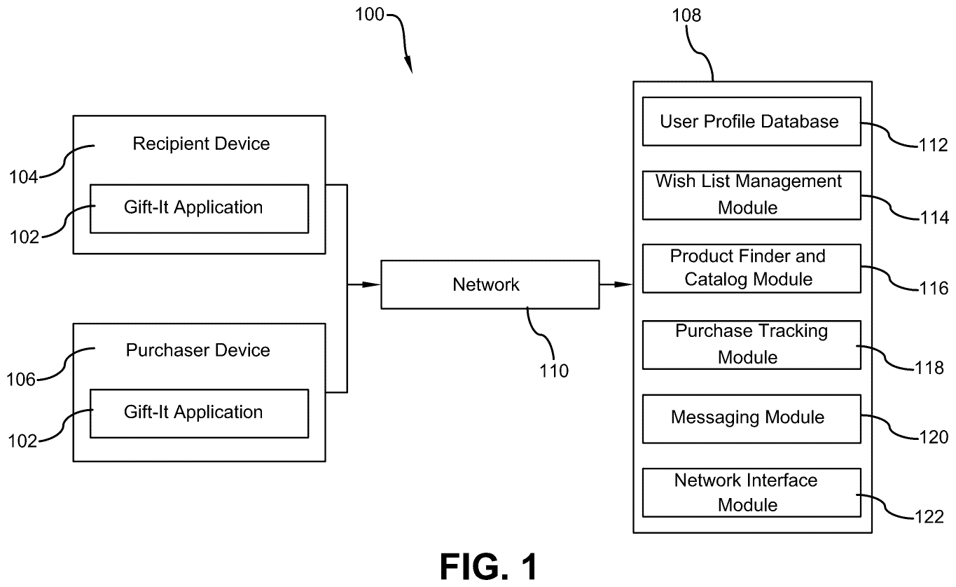

Referring initially to the drawings, FIG. 1 illustrates a block diagram view of system architecture of interactive gift shopping and management system of the present invention in accordance with the disclosed architecture. The interactive gift shopping and management system 100 of the present invention is designed to simplify the process of creating, sharing, and tracking gift wish lists. The system 100 enables users (recipients) to build electronic wish lists by adding desired products and share them with friends or family (purchasers). The system 100 provides interactive sharing and tracking architecture which enables multiple gift givers to coordinate without revealing purchases to the recipient.

More specifically, the system 100 includes at least one recipient electronic device 104 and at least one purchaser electronic device 106. Both the recipient electronic device 104 and the purchaser electronic device 106 are configured to independently execute a software application 102 installed therein. The software application 102 also referred to as “Gift-It” application in the present disclosure is configured to provide a plurality of user interfaces enabling users to create and edit wish lists, scanning and adding products to the wish lists, and communicating with other users of the system 100.

The Gift-it (i.e., electronic) application 102 can be a mobile or web-based software application configured to enable users to create, share, and manage digital wish lists, as well as to coordinate purchases among a group of users. In one embodiment, the recipient electronic device 104 is operated by a user who creates a personal wish list, while the purchaser electronic device 106 is operated by one or more users who view and purchase items from that list.

The client devices 104, 106 are communicatively coupled to a server system 108 via a network 110, which may include any combination of wired and wireless communication networks, such as the Internet, cellular networks, or local area networks (LANs).

The server system 108 includes a plurality of modules and databases for implementing the core functions of the invention. A user profile database 112 is configured to store user account information, login credentials, group associations, and device identifiers for both recipient and purchaser users. The system 100 maintains association between recipients and purchasers in the user profile database 112 which is used for providing access of the wish lists.

A wish list management module 114 is configured to handle the creation, editing, and sharing of user wish lists. The module 114 receives item data from the Gift-it (i.e., electronic) application 102 and synchronizes the wish list contents among the connected or associated users and purchasers.

A product finder and catalog module 116 is configured to process product-related data including scanned images, barcodes, or search queries which helps a user to add items to their wish list. The module 116 can interface with external merchant systems (such as third-party ecommerce websites and stores) to retrieve product details such as item descriptions, images, pricing, and purchase links, and makes such information available to users for selection and addition to wish lists.

A purchase tracking module 118 is configured to record and monitor gift purchase events made by purchaser users. The module 118 maintains real-time updates on the items stored in the wish lists and prevents duplicate purchases by updating the purchase status of each item within the system. The purchase tracking module 118 also uses privacy rules to conceal purchase information from the recipient user to maintain the element of surprise of gifting the wish list items.

A messaging module 120 enables real-time communication between users within a gift group (authorized recipients and purchasers). The module 120 supports notes, comments, and coordination messages related to particular gift items or events, thereby improving group collaboration during gift planning.

A network interface module 122 manages communication between the server system 108 and the client devices 104, 106 over the network 110. The network interface module 122 is configured to provide data transmission, encryption, synchronization, and routing between the Gift-it (i.e., electronic) application 102 and the back-end modules of the server system 108.

In operation, the recipient electronic device 104 transmits wish list data to the server system 108, and the wish list is made accessible to the authorized purchaser device(s) 106. The purchaser electronic device 106, in turn, may interact with the server 108 to mark items as purchased, add comments, or coordinate with other purchasers (who are authorized to access the wish list). The server system 108 manages visibility and synchronization among all participating devices to prevent the recipients from viewing status of the purchased items, thereby preserving the surprise element of gift-giving.

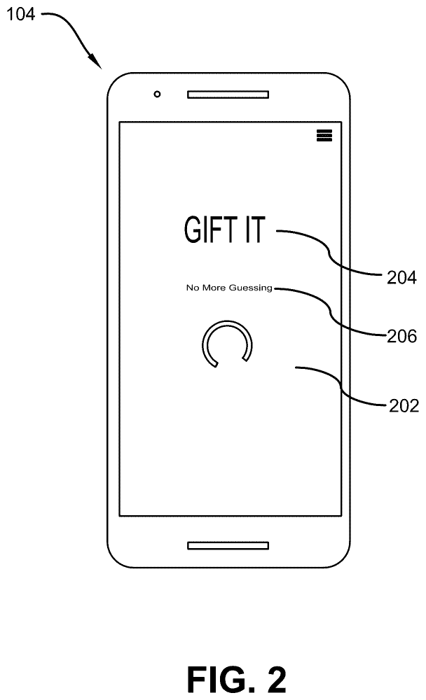

FIG. 2 illustrates an exemplary user interface displayed by the Gift-it (i.e., electronic) application, according to one embodiment of the present invention. As shown in FIG. 2, the recipient electronic device 104 can be a smartphone, tablet, or other computing device and is configured to execute the Gift-It mobile application 102. In the illustrated embodiment, the device 104 displays a splash screen 202 representing an initial loading or startup interface of the Gift-it (i.e., electronic) application. It should be noted that FIG. 2 is described in reference to the recipient electronic device 104 but a similar interface is also displayed on the purchaser electronic device.

The splash screen 202 may include a visual loading indicator and branding elements associated with the application. In one embodiment, the splash screen 202 displays the application title “GIFT IT” 204 and a loading animation positioned beneath the text to indicate that the application is initializing. The splash screen may also display a tagline 206 such as “No More Guessing,” indicating the purpose of the system 100.

During the initialization phase, the Gift-it (i.e., electronic) application 102 may establish a secure connection with the back-end server system 108 (as described with respect to FIG. 1) through the network 110 to authenticate the user, retrieve stored profile data, and synchronize wish list and messaging information.

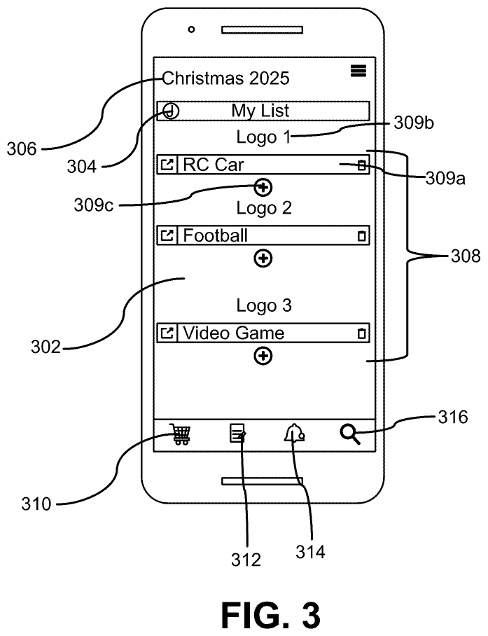

FIG. 3 illustrates an exemplary user interface of a recipient electronic device 104 executing the Gift-It mobile application, showing a personal wish list of a recipient according to one embodiment of the present invention. As shown in FIG. 3, the user interface 302 displays a wish list view corresponding to a specific gift event 306, such as “Christmas 2025.” A header section 304 identifies the active list and may include a title or event name, user identifier, and associated visual indicators or icons.

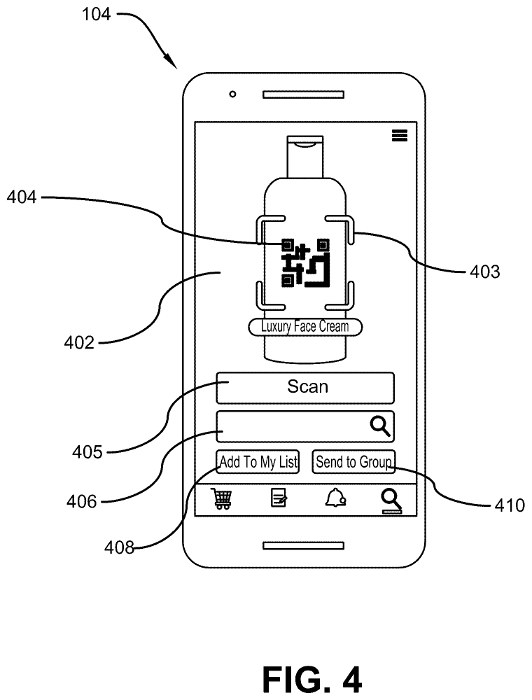

The wish list interface 302 displays a plurality of individual list entries 308, each corresponding to a specific desired item of the wish list. Each list entry may include an item description 309a (e.g., “RC Car,” “Football,” “Video Game”), an optional retailer logo or identifier 309b (e.g., Amazon®, Target®, Best Buy®), and an add or selection icon 309c enabling the user to modify or share the item. The list interface 302 enables the recipient user to populate, organize, or update wish list items either manually or through the product finder (as described in FIG. 4).

A navigation bar includes a shopping cart icon 310, a list management icon 312, a notifications icon 314, and a search icon 316. The shopping icon 310 provides access to the product finder and purchasing interface of the Gift-it (i.e., electronic) application 102. When selected, the shopping icon 310 transitions the user to a dedicated product discovery screen.

The list management icon 312 provides direct access to the personal wish list management interface. When selected, the list management icon 312 displays one or more wish lists associated with the user's account, organized by event (e.g., “Christmas 2025,” “Birthday,” “Baby Shower”).

The notifications icon 314 enables access to the alerts generated for the recipient. Upon selection, the notifications interface displays real-time updates including upcoming events such as birthdays, holidays, or registered celebrations and direct messages or comments exchanged between group participants.

The search icon 316 provides access to a search function integrated into the Gift-it (i.e., electronic) application 102. The search interface enables users to perform one or more from searching for products by name, category, or description, retrieving wish lists associated with specific users or groups, and locating previous purchase history or event records.

FIG. 4 illustrates an exemplary embodiment of a product finder interface displayed by the Gift-it (i.e., electronic) application on a recipient device, according to one embodiment of the present invention. The product finder interface 402 is configured to use the camera or scanning functionality of the recipient device to detect product information through visual or coded identifiers.

In the illustrated embodiment, the interface 402 displays a product image 404 such as a retail product. A scanning overlay 403 is positioned over the product image 404 and includes a machine-readable code area, such as a QR code or barcode, which is detected and processed by the application 102 to retrieve product details from one or more online data sources.

A scan button 405 is provided to initiate the scanning or recognition process. When the scan button 405 is selected, the application 102 activates the camera or sensor to capture the visual code or image of the product. Upon successful recognition, the application 102 communicates with the product finder and catalog module on the server (as described in FIG. 1) to obtain corresponding product information such as product name, description, retailer link, and pricing data.

Once the product information has been identified, the interface 402 provides two options wherein the first option is an “Add to My List” button 408, which enables the user or recipient to store the identified product directly in their personal wish list. The second option is a “Send to Group” button 410, enabling the user to share the product information with other members of a designated gift group for collaborative review, group decision-making, or for making a purchase.

A search input field 406 is provided for enabling users to enter product names or keywords manually if scanning is not available or desired. The search function may utilize the same product finder and catalog module on the server to retrieve relevant products.

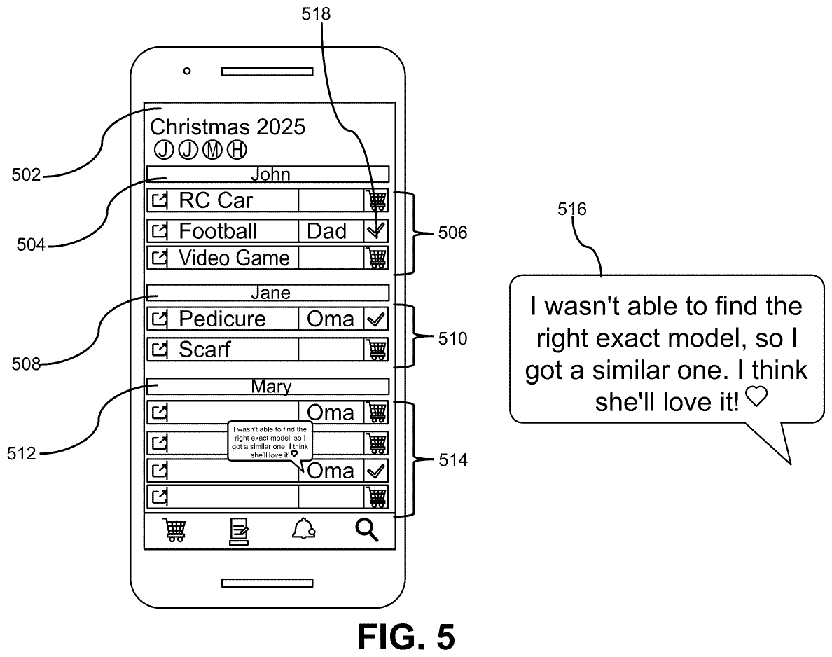

FIG. 5 illustrates an exemplary embodiment of an interactive list interface offered by the Gift-it (i.e., electronic) application, as displayed on a recipient or purchaser device according to one embodiment of the present invention. As shown in FIG. 5, the interface 502 displays a shared event-based list view (i.e., Christmas 2025) representing a plurality of recipient users and their corresponding wish lists. The interactive list interface 502 enables friends and family to view and manage gift selections collaboratively while maintaining the confidentiality of actual purchase activity from the intended recipients.

In the present embodiment, the interface 502 is divided into a plurality of sections 506, 510, 514 corresponding to individual recipients John 504, Jane 508, and Mary 512. Each section includes one or more item entries, each representing a product desired by the corresponding recipient. Next to each item entry, a purchase indicator field 518 displays purchase or reservation information for the item. The purchase indicator 518 may include a visual identifier such as the purchaser's name (e.g., “Dad,” “Oma”) and a checkmark symbol to indicate that the item has been purchased or reserved by that user.

The interface 502 further supports embedded communication and collaboration among users. As a non-limiting example, a purchaser may attach a note or comment 516 to a specific gift entry, which includes an inline message field. The comment and note features enable coordination among purchasers, enabling the purchasers to communicate about specific items, clarify substitutions, or update others on purchase status without revealing such details to the recipient.

In operation, the interactive list interface 502 retrieves and displays real-time updates from the server system. When a purchaser marks an item as purchased or posts a note, the corresponding data is transmitted to the server and synchronized with all other group (i.e., purchaser) members, excluding the recipient's view. The system 100 employs a visibility control mechanism that prevents the recipient from viewing which items have been purchased, thereby preserving the surprise of the gift-giving experience.

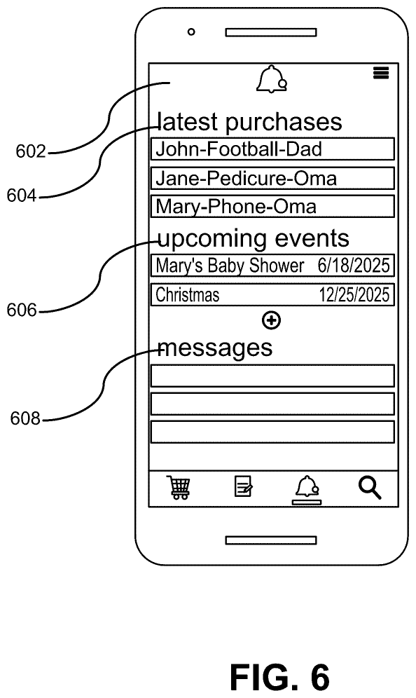

FIG. 6 illustrates an exemplary embodiment of a notifications and messaging interface offered by the Gift-it (i.e., electronic) application of the present invention in accordance with one embodiment of the disclosed architecture. As shown in FIG. 6, the interface 602 provides a consolidated view of system updates, event reminders, and user communications related to shared gift lists and purchasing activity. The interface 602 enables users to monitor recent gift transactions, view upcoming occasions, and exchange coordination messages with other members of their group.

A section labeled “latest purchases” 604 displays recent purchase activity within the connected gift groups of a user. Each entry of the section 604 identifies the recipient, the purchased item, and the purchaser (such as, Dad purchased a football for John). The section 604 is dynamically updated in real time, providing all participating purchasers remain informed of completed or pending transactions. The purchase information is restricted from visibility on the recipient's version of the application to preserve the gift's surprise element.

An “upcoming events” section 606 provides a chronological listing of approaching celebrations or milestones associated with users'groups. The section 606 can interface with the user's calendar and event management system to provide reminders and scheduling assistance. Users may also add new events or import events from external calendar applications to the section 606.

A “messages” section 608 enables direct communication between group members. The messaging enables users to coordinate gift purchases, share ideas, and discuss group logistics without leaving the application. Messages are synchronized through the messaging module of the server system (FIG. 1) and are displayed in thread form within the section 608.

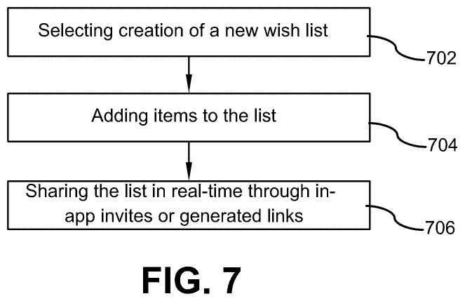

FIG. 7 illustrates an exemplary flow diagram depicting a method for creating and sharing a wish list using the Gift-it (i.e., electronic) application in accordance with the disclosed architecture. Initially, a user creates a new wish list (Step 702). The step may include the option to name the list according to a specific occasion, such as a holiday, birthday, or celebration. The system may prompt the user to input event-related metadata such as title, date, or associated group participants.

Then, the user adds items to the list (Step 704). The user may populate the wish list manually by typing product information, by copying direct links from online retailers, or by utilizing the product finder feature to photograph, scan, or search for desired items. Once identified, item data is transmitted to the server (described in FIG. 1) where the list is stored and synchronized with the user's account. Each item may include associated product metadata such as product name, image, merchant source, and price.

Thereafter, the user may share the list via in-app invites to selected contacts or through the generation of secure shareable links that may be distributed through messaging platforms, email, or social media (Step 706).

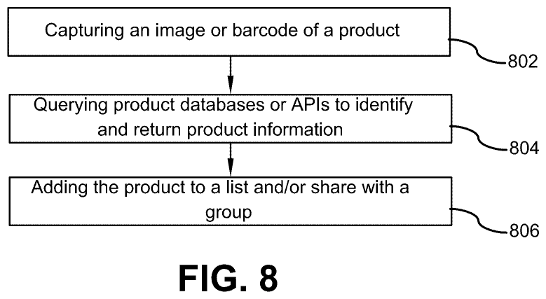

FIG. 8 illustrates an exemplary method for identifying and adding a product to a wish list or shared group using the Gift-it (i.e., electronic) application, according to one embodiment of the present invention. Initially, the user performs the step of capturing an image or barcode of a product (Step 802). The user may activate the integrated camera or scanner of the device within the Gift-it (i.e., electronic) application's product finder interface (as previously described in FIG. 4). The captured input may include a barcode, QR code, or visual image of the product, which is processed locally or transmitted to a back-end server for recognition and identification.

At step 804, the method proceeds to querying product databases or application programming interfaces (APIs) to identify and return product information corresponding to the captured image or code. In one embodiment, the Gift-it (i.e., electronic) application communicates with the product finder and catalog module (see FIG. 1) to access one or more third-party retail databases or online store APIs. The databases may return product data such as item title, description, price, availability, and source website link. The system may also use machine vision algorithms or metadata matching to confirm and refine product identification.

Finally, the identified product is added to a list and/or shared with a group (Step 806). The user may choose to save the product directly to their personal wish list or send it to a designated group for review and discussion. When the product is shared, the Gift-It server system synchronizes the product entry with all authorized group members'devices in real time.

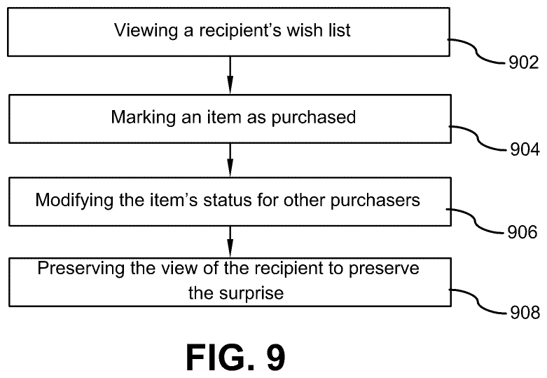

FIG. 9 illustrates an exemplary method for tracking purchases and preserving recipient privacy within the Gift-it (i.e., electronic) application in accordance with the disclosed architecture. Initially, a purchaser views a recipient's wish list through the Gift-it (i.e., electronic) application (Step 902). The wish list may include product names, links, and availability details, synchronized in real time with the Gift-It server.

Next, a purchaser performs the action of marking an item on the wish list as purchased (Step 904). The action may occur by selecting a purchase confirmation icon or interacting with the item entry on the list interface.

In the next step 906, the system 100 automatically modifies the item's status for other purchasers. The server updates the shared group view so that other purchasers see the item as “purchased” or “reserved,” preventing duplicate transactions. The update occurs in real time across all connected devices. The modified purchase status may include identifiers such as the purchaser's name or a confirmation checkmark, visible only to authorized purchaser users within the group.

Finally, the system 100 maintains a selective visibility to preserve the view of the recipient and maintain the element of surprise (Step 908). The recipient's view of the wish list remains unmodified to conceal which items have been purchased, even though the system internally tracks those purchases.

It should be noted that when a user device initiates a request to retrieve wish list data from the server, the system first evaluates the user's role within the group, specifically identifying whether the requester is a recipient or a purchaser. The server may perform the evaluation using stored user profile data and group relationship mappings maintained in the user profile database. Based on the determined role and associated permissions, the system dynamically filters the data before transmission. In one embodiment, purchasers are provided with full visibility of the list, including items that have been marked as purchased or reserved by other group (i.e., purchaser) members, thereby enabling coordinated gift buying and duplication prevention. In contrast, recipients are served a filtered version of the list with any purchase indicators, notes, or related metadata withheld to preserve the element of surprise.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “interactive gift shopping and wish-list management system”, “role-based digital gift coordination and privacy-preserving wish-list system”, “gift shopping and management system”, and “system” are interchangeable and refer to the interactive gift shopping and wish-list management system 100 of the present invention.

Notwithstanding the forgoing, the interactive gift shopping and wish-list management system 100 of the present invention can be of any suitable configuration as is known in the art without affecting the overall concept of the invention, provided that it accomplishes the above stated objectives. One of ordinary skill in the art will appreciate that the interactive gift shopping and wish-list management system 100 shown in the FIGS. are for illustrative purposes only, and that many other configurations of the interactive gift shopping and wish-list management system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interactive gift shopping and management system comprising:
an electronic mobile application;
a recipient;
a plurality of purchasers;
an electronic wish list;
a recipient electronic device;
a plurality of purchaser electronic devices; and
a server system;
wherein said recipient builds said electronic wish list by adding desired products for sharing with said plurality of purchasers;
wherein said electronic mobile application comprises interactive sharing and tracking of said electronic wish list;
wherein said recipient electronic device and said plurality of purchaser electronic devices are wirelessly connected to said electronic mobile application;
wherein said electronic mobile application is a mobile web-based software application configured to enable said recipient and said plurality of purchasers for creating, sharing, and managing said electronic wish list;
wherein said recipient electronic device is operated by said recipient for said creating said electronic wish list;
wherein said plurality of purchaser electronic devices are operated by said plurality of purchasers for viewing and purchasing an item from said electronic wish list;
wherein said recipient electronic device communicatively coupled to said plurality of purchaser electronic devices with said server system;
wherein said server system is a wireless network selected from the group consisting of an Internet, a cellular network, and a local area networks (LANs); and
an electronic wish list management module for receiving product data of said products from said electronic mobile application and synchronizes said electronic wish list with said recipient account information and said plurality of purchasers account information, wherein a purchase by one of said plurality of purchasers notifies others consisting of all other said plurality of purchasers that said purchase was completed.

2. The interactive gift shopping and management system of claim 1 further comprising a user profile database configured to store said recipient account information and said plurality of purchasers account information.

3. The interactive gift shopping and management system of claim 2, wherein said electronic wish list management module configured to manage operations of said electronic wish list selected from the group consisting of selecting, editing, and purchasing said products from said electronic wish list.

4. The interactive gift shopping and management system of claim 3, wherein said electronic wish list management module excludes said recipient from said notification of said purchase.

5. The interactive gift shopping and management system of claim 4 further comprising a product finder and catalog module configured to process said product data comprising information selected from the group consisting of scanned images, barcodes, and search queries for adding said products by said recipient to said electronic wish list.

6. The interactive gift shopping and management system of claim 5, wherein said product finder and catalog module interfaces with external merchant systems to retrieve said product data selected from the group consisting of item descriptions, item images, item pricing, and item purchase links and makes said product data available to said recipient for selection and addition to said electronic wish list.

7. The interactive gift shopping and management system of claim 6 further comprising a purchase tracking module configured to record and monitor said purchase of said products made by said plurality of purchasers.

8. The interactive gift shopping and management system of claim 7, wherein said purchase tracking module maintains real-time updates on said product data stored in said electronic wish list.

9. The interactive gift shopping and management system of claim 8, wherein said purchase tracking module conceals purchase information made by said plurality of purchasers from said recipient.

10. The interactive gift shopping and management system of claim 9 further comprising a messaging module to provide real-time communication between said recipient and a select group of said plurality of purchasers.

11. The interactive gift shopping and management system of claim 10, wherein said messaging module is configured to provide notes, comments, and coordination messages related to said purchase of said products between said select group of said plurality of purchasers.

12. The interactive gift shopping and management system of claim 11 further comprising a network interface module to manage communication between said server system and said recipient electronic device and said plurality of purchaser electronic devices over said network.

13. The interactive gift shopping and management system of claim 12, wherein said recipient electronic device transmits said electronic wish list to said server system and makes accessible said electronic wish list to said plurality of purchaser electronic devices.

14. The interactive gift shopping and management system of claim 13, wherein said recipient electronic device and said plurality of purchaser electronic devices selected from the group consisting of a smartphone, a tablet, and a portable computing device configured to execute said electronic mobile application.

15. The interactive gift shopping and management system of claim 14, wherein said electronic wish list is sorted into specific gift events.

16. A method of interactive gift shopping, the method comprising the steps of:
providing an electronic mobile application, a recipient, a plurality of purchasers, an electronic wish list, a recipient electronic device, a plurality of purchaser electronic devices; a server system, and an electronic wish list management module;
building said electronic wish list by said recipient and adding desired products for sharing with said plurality of purchasers;
interactive sharing and tracking of said electronic wish list between said recipient and said plurality of purchasers;
wirelessly connecting said recipient electronic device and said plurality of purchaser electronic devices to said electronic mobile application, wherein said electronic mobile application is a mobile web-based software application configured to enable said recipient and said plurality of purchasers for creating, sharing, and managing said electronic wish list;
wherein said recipient electronic device is operated by said recipient for said creating said electronic wish list;
viewing and purchasing an item from said electronic wish list by said plurality of purchasers;
communicatively coupling said recipient electronic device to said plurality of purchaser electronic devices with said server system;
wherein said electronic wish list management module receives product data of said products from said electronic mobile application; and
synchronizing said electronic wish list with said recipient account information and said plurality of purchasers account information, wherein a purchase by one of said plurality of purchasers notifies others consisting of all other said plurality of purchasers that said purchase was completed.

17. The method of interactive gift shopping of claim 16, wherein each said product comprising a product scanning overlay positioned over a product image of said product, further wherein said product scanning overlay comprises a machine-readable code area which is detected and processed by said electronic mobile application to retrieve product details for said product.

18. A method of interactive gift shopping, the method comprising the steps of:
providing an electronic mobile application, a recipient, a plurality of purchasers, an electronic wish list, a recipient electronic device, a plurality of purchaser electronic devices;
a server system, and an electronic wish list management module;
building said electronic wish list by said recipient and adding desired products for sharing with said plurality of purchasers;
interactive sharing and tracking of said electronic wish list between said recipient and said plurality of purchasers;
wirelessly connecting said recipient electronic device and said plurality of purchaser electronic devices to said electronic mobile application, wherein said electronic mobile application is a mobile web-based software application configured to enable said recipient and said plurality of purchasers for creating, sharing, and managing said electronic wish list, wherein said recipient electronic device is operated by said recipient for said creating said electronic wish list;
viewing a purchased item from said electronic wish list by said plurality of purchasers;
communicatively coupling said recipient electronic device to said plurality of purchaser electronic devices with said server system, wherein said electronic wish list management module receives product data of said products from said electronic mobile application;
synchronizing said electronic wish list with said recipient account information and said plurality of purchasers account information;
viewing said purchased item through said interactive list interface by said plurality of purchasers; and
identifying said recipient, said purchased item, and said purchaser, wherein said purchased item by one of said plurality of purchasers notifies others consisting of all other said plurality of purchasers that said purchased time was completed.

19. The method of interactive gift shopping of claim 18, wherein each said product comprising a product scanning overlay positioned over a product image of said product, further wherein said product scanning overlay comprises a machine-readable code area which is detected and processed by said electronic mobile application to retrieve product details for said product.

20. The method of interactive gift shopping of claim 19, wherein said electronic wish list is sorted into specific gift events.
